(19) United States
(12) Patent Application Publication
(10) Pub. No.: US 2017/0089327 A1
(43) Pub. Date: Mar. 30, 2017

(54) WIND-TURBINE ROTOR BLADE AND HEATING UNIT FOR A WIND-TURBINE ROTOR BLADE

(71) Applicant: WOBBEN PROPERTIES GMBH, Aurich (DE)

(72) Inventor: Jürgen STOLTENJOHANNES, Aurich (DE)

(21) Appl. No.: 15/126,570

(22) PCT Filed: Mar. 12, 2015
(86) PCT No.: PCT/EP2015/055232

§ 371 Date: Sep. 15, 2016

(30) Foreign Application Priority Data
Mar. 17, 2014 (DE) 102014204857.5

(51) Int. Cl. F03D 80/40; G02B 6/42; F03D 7/04; F03D 1/06; F03D 17/00; F03D 80/30

(52) U.S. Cl. CPC F03D 80/40; F03D 17/00; F03D 80/30; F03D 7/042; F03D 1/0675; G02B 6/4266; G02B 6/4286; F05B 2220/706; F05B 2240/2211; F05B 2260/20

(57) ABSTRACT

A wind turbine rotor blade with a heating unit for heating the rotor blade is provided. The heating unit has at least one optical waveguide as a heating element. The heating unit has at least one connection for an energy source or an emitter, which can emit energy in the form of electromagnetic waves through the optical waveguide. The light is converted into heat by the attenuation losses of the optical waveguide.

### BACKGROUND

Technical Field

The present disclosure relates to a wind turbine rotor blade and to a heating unit for a wind turbine rotor blade.

Description of the Related Art

The rotor blades of a wind turbine are exposed to the forces of nature unprotected. Both the rotor blades and the wind turbine as a whole must be able to operate in a wide temperature range. However, particularly at temperatures around or below freezing, icing of the rotor blades may occur. There are some existing known methods for heating rotor blades (for example by air heating) and for deicing the rotor blades or for preventively avoiding icing.

DE 10 2011 086 603 A1 discloses a wind turbine rotor blade and a method for deicing a wind turbine rotor blade by means of air heating.

In the priority-establishing patent application, the German Patent and Trademark Office has searched the following documents: DE 10 2011 086 603 A1, DE 100 16 259 C2, DE 10 2004 042 423 A1, JP 2001-122533 A, EP 2 386 750 A1, DE 10 2009 039 490 A1.

Electrically operated heated mats, which have at least one electrical line as a heating element, may be used as an alternative to this. The use of electrical lines in the heating mat, which is then placed in the rotor blade or is integrated in the rotor blade, is however disadvantageous with regard to the risk of a lightning strike.

### BRIEF SUMMARY

Embodiments of the present disclosure provide a wind turbine rotor blade and a heating element for a wind turbine rotor blade that reduces the risk of a lightning strike.

Consequently, a wind turbine rotor blade with a heating unit for heating the rotor blade is provided. The heating unit has at least one optical waveguide as a heating element. The heating unit has at least one connection for an energy or light source or an emitter, which can emit energy in the form of electromagnetic beams or waves, for example light, through the optical waveguide. The electromagnetic waves are converted into heat by the attenuation losses of the optical waveguide.

The attenuation of the optical waveguide is optionally chosen such that the electromagnetic beams or waves coupled in by way of the light source or the energy source, for example light, are converted into heat as uniformly as possible over the length of the optical waveguide.

According to one aspect of the present disclosure, a heating unit is integrated in the rotor blade or is attached to the rotor blade.

The heating unit may also be designed as a mat, for example a silicone mat, that has a plurality of optical waveguides which on the basis of their attenuation, convert electromagnetic waves conducted through them, for example light, into heat. This heat can then be used for warming or heating a rotor blade.

Consequently, the optical waveguides used according to the disclosure do not necessarily correspond to the optical waveguides that are usually used for optical data communication, which are designed such that the attenuation is minimized. While the attenuation is undesired in the case of optical data communication, the attenuation of the optical waveguides according to the disclosure is desired, in order to be able to heat the rotor blade.

The disclosure likewise relates to a heating unit for a wind turbine rotor blade. The heating unit has an input connection for coupling in electromagnetic waves, for example light, and at least one optical waveguide as a heating element. The heating unit may optionally be designed as a mat with an input connection. This allows the mat to be integrated in the rotor blade or attached to its inner side. The mat may be integrated into the material of the rotor blade.

The heating unit may optionally be arranged as close as possible to the outer surface of the rotor blade, in order to be able to heat the outer region in particular.

According to one aspect of the present disclosure, the attenuation is chosen such that there can be a uniform heat dissipation along the length of the at least one optical waveguide.

A grid of optical waveguides may be optionally provided in the rotor blade or in the heating unit.

The solution according to the disclosure is advantageous because with it both lightning strikes and static electrical charging can be avoided or reduced. The optical waveguides typically serve for the transmission of light and consist of fibers, such as for example quartz glass or plastic (polymeric optical fibers). This allows the optical waveguides to be integrated very well into the conventional structure of the blade, for example consisting of GRP or CRP. Furthermore, the optical waveguides behave uncritically with respect to durability.

Further refinements of the disclosure are the subject of the subclaims.

### BRIEF DESCRIPTION OF THE SEVERAL VIEWS OF THE DRAWINGS

Advantages and exemplary embodiments of the disclosure are explained in more detail below with reference to the drawing.

FIG. 1 shows a schematic representation of a wind turbine according to the disclosure,

FIGS. 2A to 2B respectively show a schematic view of a rotor blade according to a first exemplary embodiment of the disclosure,

FIG. 3 shows a schematic cross section of a rotor blade according to a second exemplary embodiment, and

FIG. 4 shows a schematic view of a rotor blade according to a third exemplary embodiment.

### DETAILED DESCRIPTION

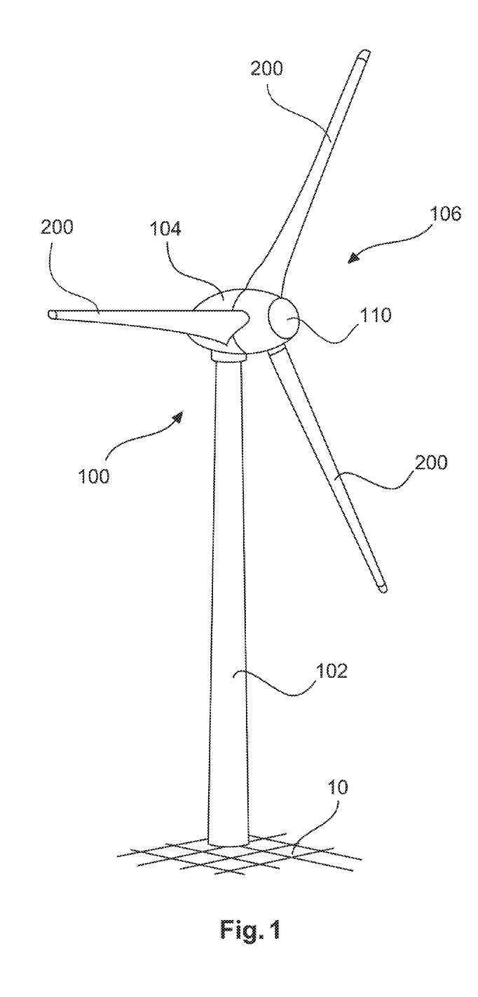

FIG. 1 shows a schematic representation of a wind turbine according to the disclosure. The wind turbine 100 has a tower 102 and a nacelle 104 on the tower 102. Provided on the nacelle 104 is an aerodynamic rotor 106 with three rotor blades 200 and a spinner 110. During the operation of the wind turbine, the aerodynamic rotor 106 is set in a rotary motion by the wind, and thereby also turns a rotor of a generator that is directly or indirectly coupled to the aerodynamic rotor 106. The electrical generator is arranged in the nacelle 104 and generates electrical energy. The pitch angles of the rotor blades 200 can be adjusted by pitch motors at the rotor blade roots of the respective rotor blades 200.

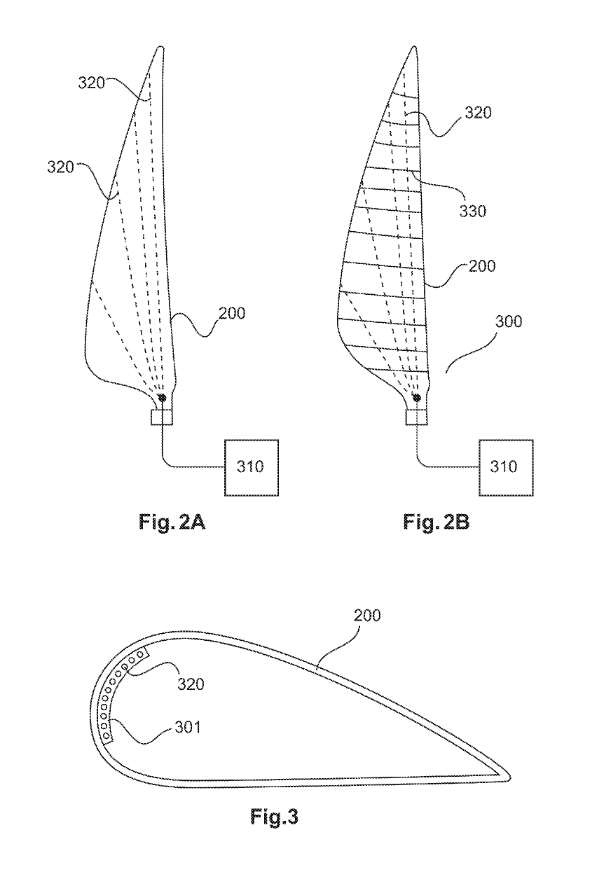

FIG. 2A shows a schematic representation of a rotor blade 30 of the wind turbine from FIG. 1 together with a heating unit.

FIGS. 2A and 2B respectively show a schematic view of a wind turbine rotor blade with a heating unit 300 according to a first exemplary embodiment of the disclosure. The heating unit 300 has an emitter or a coupling-in unit 310 for providing energy (electromagnetic radiation or waves) and at least one optical waveguide 320, which extends along the length of the rotor blade 200. The electromagnetic waves, for example light, made available by the emitter or the coupling-in unit 310 are coupled into a first end of the optical waveguides 320 and are conducted through the optical waveguide 320. The electromagnetic waves, for example light, can be converted into heat by the attenuation of the optical waveguides.

In FIG. 2B, the heating unit 300 has an emitter 310 and an optical waveguide grid structure consisting of optical waveguides 320, which extend substantially along the length of the rotor blade, and of optical waveguides 330, which extend transversely to the longitudinal direction of the rotor blade. The optical waveguides 320, 300 are connected to an energy source or an emitter or a coupling-in unit 310. The attenuation of the optical waveguides is designed such that at least part of the light coupled in is converted into heat and can be used for heating the rotor blade.

According to the disclosure, one coupling-in unit or multiple coupling-in units may be provided for the coupling in of light. The coupling-in unit is preferably provided in the region of the rotor blade root or in the region of the rotor blade hub. The optical waveguides may optionally be arranged as close as possible to the outer surface of the rotor blade, in order to warm this region in particular.

The disclosure is based on the idea of using optical waveguides as heating elements for a heating unit of a rotor blade. This initially appears to be counter-productive, since optical waveguides are typically designed such that the attenuation is minimized. However, the disclosure concerns the idea of designing the attenuation of the optical waveguides such that part of the amount of light provided in the waveguide is converted into heat and can thereby warm the rotor blade.

FIG. 3 shows a schematic cross section of a rotor blade according to a second exemplary embodiment. The rotor blade 200 has a heating unit 300 on its inner side. The heating unit 300 may be designed as a heating mat 301, which may for example be attached or fastened to the inner surface of the rotor blade 200. As an alternative or in addition, the heating mats may be integrated into the material of the rotor blade during the production of the rotor blade. The heating mat 301 may have a plurality of optical waveguides 320. Each heating mat 301 may optionally have its own coupling unit or emitter 310 for coupling light into the optical waveguides. The heating mat may be designed as a silicone mat.

The disclosure likewise relates to a heating unit with optical waveguides as a heating element (as described above), the heating unit being used for example as heating for the seats in a car or the like.

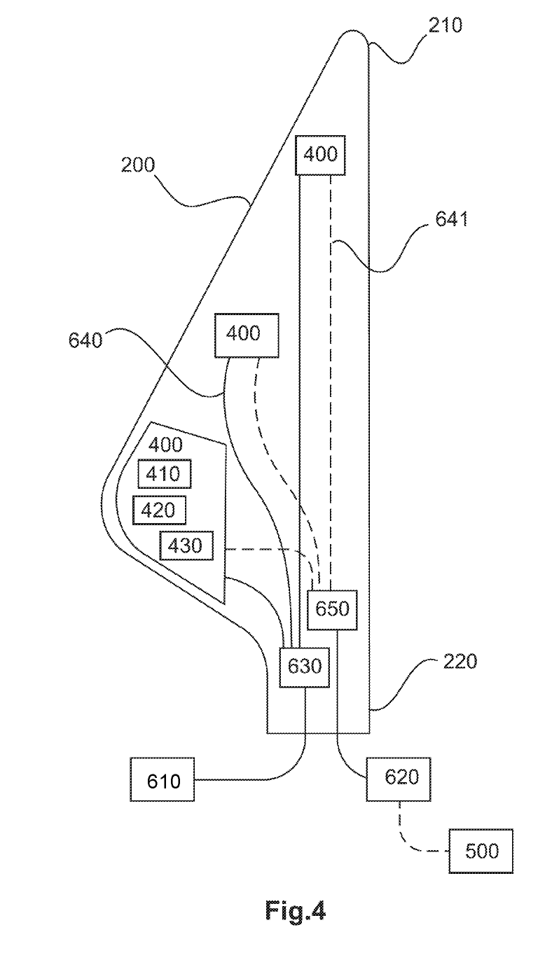

FIG. 4 shows a schematic view of a rotor blade according to a third exemplary embodiment. The rotor blade 200 has a rotor blade tip 210 and a rotor blade root 220. The rotor blade 200 is preferably produced from a fiber composite material, such as for example GRP or CRP. The rotor blade 200 has multiple sensors or measuring instrument units 400 for measuring physical variables. In the region of the rotor blade root 220, a coupling-in unit 630 is provided. Likewise in the region of the rotor blade root, an optical receiver 650 is provided. The optical receiver 650 is coupled to an evaluation unit 620. The coupling-in unit 630 is coupled to an energy supply 610. The sensors or the measuring instrument units 400 are coupled to the receiver 650 and the coupling-in unit 630 by way of optical waveguides 640, 641. Various optical waveguides 640, 641 for this are represented in FIG. 4. As an alternative to this, however, just one optical waveguide 640 may also be provided from the coupling-in unit 630 to the sensor or the measuring instrument unit 400. This optical waveguide 640 then serves both for the energy transmission from the coupling-in unit 630 to the sensors or measuring instrument units 400 and for the transmission of data from the sensors 400 to the receiver 650.

The sensor or the measuring instrument unit 400 has a coupling-out unit 410 for receiving the electromagnetic waves, for example in the form of light, by way of the optical waveguide 640 and for converting these electromagnetic waves into electrical energy. The function of the coupling-out unit 410 consequently corresponds substantially to the function of a photovoltaic unit or a photoelectric unit, since this unit converts the received electromagnetic waves, for example light, into electrical energy. The sensor or the measuring instrument unit has a corresponding sensor 420 and an optical transmitter 430. The transmitter 430 can convert the electrical output signals of the sensor 420 into optical signals and can pass these signals on to an optical receiver 650 by way of the optical waveguide 640 or 641.

Consequently, the optical waveguides 640 are used in the direction from the coupling-in unit 630 to the sensors or the measuring instrument units for supplying energy and are used in the direction from the sensors or the measuring instrument unit to the receiver 650 for data transmission of the output signals of the sensors.

The receiver 650 receives the optical signals from the optical transmitters 430 by way of the optical waveguides 640, 641 and converts these signals into electrical signals. The electrical signals are then fed to an evaluation unit 620.

The evaluation unit 620 may pass on the evaluated measuring signals of the sensors and/or of the measuring instrument units 400 to a central controller 500, which on the basis of the measuring signals recorded can intervene in the operation of the wind turbine. This may take place for example by changing the pitch angle of the wind turbines, by changing the azimuth angle or the like.

According to one aspect of the present disclosure, the coupling-in unit 630 and/or the receiver 650 may likewise have an optical transmitter, by means of which data signals can be transmitted to the sensors 400. This data communication may take place for example for controlling the sensors and/or the measuring instrument units 400.

The coupling-in unit 610 and/or the evaluation unit 620 may be provided in the region of the rotor blade root 220 or in the region of a hub of the wind turbine.

With the coupling-in unit 610, for example, electrical energy can be converted into optical signals, and consequently optical energy. This optical energy may be transmitted by means of the optical waveguides 630 to the sensors and/or the measuring instrument units. In the sensors and/or measuring instrument units, the coupled-in optical energy may be converted by means of the coupling-out unit 410 into electrical energy, which can then be used for supplying energy to the sensors 400. Optionally, the sensors 400 may have an energy store, for example in the form of at least one capacitor.

The transmitter 430 is designed for converting the electrical output signals of the sensors 420 into optical signals with defined amplitudes and/or frequencies and then transmitting these optical signals by way of the optical waveguides to the optical receiver 650.

In the evaluation unit 620, the measuring signals of the sensors and/or the measuring instrument units 400 may for example be subjected to a spectrum analysis.

The sensors 400 may for example have strain gauges as sensors 420.

With a rotor blade according to the disclosure that has an energy transmission for the sensors and/or measuring instrument units on the basis of optical waveguides, the risk of lightning strikes and/or static charges is significantly reduced because there are no electrical lines.

Since the optical waveguides are typically glass fibers, integration of these optical waveguides in the material of the rotor blade is uncritical. In particular, the optical waveguides and the fiber composite materials that are typically used in the case of rotor blades have the same coefficients of expansion.

According to the disclosure, a coupling-in unit or multiple coupling-in units may be provided for the coupling in of light. The coupling-in unit is preferably provided in the region of the rotor blade root or in the region of the rotor blade hub.

The physical variables that can be measured by the sensors 400 are for example acceleration, speed, blade loading, blade stress, temperature, air pressure, atmospheric humidity, blade bending, torque, etc.

According to the third exemplary embodiment, the optical waveguides may be used like the optical waveguides in the first or second exemplary embodiment not only for energy transmission and data transmission but also for heating or warming the rotor blade. All that is necessary for this purpose is for the coupling-in unit 310 according to the first or second exemplary embodiment to be provided.

As an alternative to this, the optical waveguides 320, 330 according to FIGS. 2A and 2B may be used for energy and/or data transmission.

1. A wind turbine rotor blade, comprising:
at least one heating unit configured to heat at least a portion of the rotor blade,
the at least one heating unit having at least one optical waveguide as a heating element such that when energy from electromagnetic waves or beams that is provided to the optical waveguides the energy is converted into heat based on attenuation of the optical waveguides.

2. The wind turbine rotor blade according to claim 1, wherein:
the energy is electromagnetic waves, the at least one heating unit having at least one emitter or a coupling-in unit for providing the electromagnetic waves to the optical waveguides.

3. The wind turbine rotor blade according to claim 1, wherein:
the attenuation of the optical waveguides is set such that at least part of the energy of the electromagnetic waves is converted into heat to heat the rotor blade.

4. The wind turbine rotor blade according to claim 1, wherein:
the at least one heating unit is integrated in the rotor blade or attached to a surface of the rotor blade.

5. The wind turbine rotor blade according to claim 1, wherein:
the at least one heating unit has at least one heating mat, the at least one optical waveguide being located in the at least one heating mat.

6. The wind turbine rotor blade according to claim 1, comprising:
a rotor blade tip and a rotor blade root,
at least one measuring instrument unit configured to measure one or more parameters related to the wind turbine rotor blade, and
an energy supply unit for supplying energy to the at least one measuring instrument unit,
the energy supply unit having a plurality of optical waveguides, for transmitting the energy to the at least one measuring instrument unit.

7. The wind turbine rotor blade according to claim 6, comprising:
a coupling-in unit in a region of the rotor blade root configured to convert electrical energy into optical energy, the optical energy being provided to the at least one optical waveguide,
the at least one measuring instrument units being configured to convert optical energy received by the at least one optical waveguides into electrical energy.

8. The wind turbine rotor blade according to claim 6, wherein:
the at least one measuring instrument units respectively have at least one sensor for measuring physical variables and a transmitter, wherein the transmitter is configure to convert output signals of the respective sensor into optical signals and transmitting the optical signals through the optical waveguides.

9. A wind turbine, comprising:
at one rotor blade according to claim 6 and
an evaluation unit configured to evaluate the received signals of the at least one measuring instrument units.

10. The wind turbine according to claim 9, comprising:
a central control unit configured to adjust an operation of the wind turbine based on signals received from one of the at least one measuring instrument unit and the evaluation unit.

11. A wind turbine, comprising:
at least one wind turbine rotor blade according to claim 1.

12. A heating unit comprising:
at least one optical waveguide as a heating element such that when energy in the form of electromagnetic waves is coupled into the at least one optical waveguide the energy is converted into heat based on an attenuation of the optical waveguides, the heating unit being configured for use with a wind turbine rotor blade for heating at least a portion of the rotor blade.

13. (canceled)

14. A method comprising:
heating a wind turbine rotor blade using at least one optical waveguide, wherein heating includes:
providing energy in the form of electromagnetic waves or beams in the at least one optical waveguide, the electromagnetic waves being converted into heat based on attenuation in the optical waveguide.

15. The wind turbine rotor blade according to claim 1, wherein the electromagnetic waves are light waves.
